(19) United States
(12) Patent Application Publication
(10) Pub. No.: US 2026/0043737 A1
(43) Pub. Date: Feb. 12, 2026

(54) SPECTROMETER DEVICE AND SYSTEM FOR DETECTING INCIDENT RADIATION GENERATED BY AN OBJECT

(71) Applicant: TRINAMIX GMBH, Ludwigshafen Am Rhein (DE)

(72) Inventors: Felix SCHMIDT, Ludwigshafen am Rhein (DE); Henning ZIMMERMANN, Ludwigshafen am Rhein (DE)

(21) Appl. No.: 19/103,035

(22) PCT Filed: Sep. 14, 2023
(86) PCT No.: PCT/EP2023/075221

§ 371 Date: Feb. 11, 2025

(30) Foreign Application Priority Data
Sep. 15, 2022 (EP) 22195914.1

(51) Int. Cl. G01N 21/31

(52) U.S. Cl. CPC G01N 21/31; G01N 2201/0636

(57) ABSTRACT

Disclosed herein is a spectrometer device for detecting incident radiation generated by an object and a spectrometer system

The spectrometer device and the spectrometer system for detecting incident radiation generated by an object includes: a measurement window, a detector array, an optical filter, and at least one optical element configured for modifying the field of view of at least one pixelated sensor by increasing at least one overlap between the field of views of the at least two pixelated sensors.

Further described herein is the advantage that the spectrometer device and the spectrometer system are robust against the granularity of an object, particularly by providing a sensor signal that may be correlated in a common measurement result, as the fields of view of the single pixelated sensors have an increased overlap.

### TECHNICAL FIELD

The invention relates to a spectrometer device for detecting incident radiation generated by an object and a spectrometer system. Such a spectrometer device and such a spectrometer system may, in general, be employed for investigation or monitoring purposes.

### BACKGROUND ART

Optical metrology systems, typically, enable reliable, fast, and non-invasive measurements for a large range of applications, including, but not limited to, imaging, microscopy, distance measurement, spectroscopy, astronomy, each, generally, in a plurality of variations and implementations.

Specifically in diffusive reflective spectroscopy strongly granular objects may be measured. Such granular objects may be known from agricultural applications and may include, but are not limited to, grains and/or soils. Further such granular objects may be known from material classification applications including, but not limited to, plastics sorting or classification of fabrics. However, further kinds of applications are possible.

Spectrometer devices using a plurality of sensors each having an individual field of view may be sensitive to the granularity of an object, particularly, in case the width of the individual field of views and the distance between two neighboring fields of views may be within the order of magnitude of a typical structure size and/or correlation length of the object. Particularly in case the individual field of views of the plurality of sensors may be directed at different portions of the object, the sensor signals generated by the individual sensors may be influenced by the granularity of the object. It may be required that the individual sensor signals may have to be combined. As an example, the individual sensors may measure a partition of a spectrum so that only the combination of the individual sensor signals may give the full spectrum. For such measurements, the dependence of the individual sensor signals on the granularity may affect the combination of the individual sensor signals and may even introduce a measurement error.

US 2015/0288894 A1 discloses a spectral camera for producing a spectral output. The spectral camera has an objective lens for producing an image, an array of mirrors, an array of filters for passing a different passband of the optical spectrum for different ones of the optical channels arranged so as to project multiple of the optical channels onto different parts of the same focal plane, and a sensor array at the focal plane to detect the filtered image copies simultaneously. By using mirrors, there may be less optical degradation and the tradeoff of cost with optical quality can be better. By projecting the optical channels onto different parts of the same focal plane a single sensor or coplanar multiple sensors can to be used to detect the different optical channels simultaneously which promotes simpler alignment and manufacturing.

US 2002/0039186 A1 relates to spectral analysis systems and methods for determining physical and chemical properties of a sample by measuring the optical characteristics of light emitted from the sample. In one embodiment, a probe head for use with a spectrometer includes a reflector for illuminating a sample volume disposed circumferentially about the light source of the probe head. In another embodiment, a probe head includes an optical blocking element for forcing the optical path between the light source and an optical pick-up optically connected to the spectrometer into the sample. The probe head also includes a reference shutter for selectively blocking light emitted from the sample from reaching the optical pick-up to facilitate calibration of the spectrometer.

US 2017292908A1 discloses a spectrometer system that may be used to determine one or more spectra of an object, and the one or more spectra may be associated with one or more attributes of the object that are relevant to the user. While the spectrometer system can take many forms, in many instances the system comprises a spectrometer and a processing device in communication with the spectrometer and with a remote server, wherein the spectrometer is physically integrated with an apparatus. The apparatus may have a function different than that of the spectrometer, such as a consumer appliance or device.

U.S. Pat. No. 5,729,011 A discloses a spectroscopic apparatus capable of simultaneously producing spectroscopic images corresponding to a plurality of wavelengths and a spectroscopic image recording apparatus capable of recording the produced spectroscopic images, wherein an image producing unit produces a plurality of same images from a single input image by dividing a pupil of an optical system, a first spectroscopic unit produces a plurality of first spectroscopic images corresponding to the plurality of same images by extracting a predetermined wavelength component corresponding to each of the plurality of same images, and a second spectroscopic unit produces a plurality of second spectroscopic images corresponding to respective ones of the first spectroscopic images by extracting a predetermined wavelength component corresponding to each of the first spectroscopic images corresponding to the plurality of same images.

CN 114 360 364 A discloses a multispectral imaging module and a portable display device, and relates to the technical field of imaging spectrum detection instruments. The multispectral imaging module comprises a primary mirror used for correcting aberration, a micro lens array, an array optical filter and a detector which are sequentially arranged along an optical path. The number of channels of the micro lens array corresponds to the number of channels of the array optical filter to form a plurality of imaging channels. The light beam emitted by the primary mirror sequentially passes through the micro-lens array and the array optical filter, so that light of different wavebands of the light beam is imaged at corresponding positions of the detector through the corresponding imaging channels, and multispectral imaging is achieved. A micro lens array mode is adopted, a data cube of an object can be obtained through one-time collection.

### Problem to be Solved

It is therefore desirable to provide a spectrometer device and a spectrometer system which at least partially overcome the problems of the state of the art. It is further desirable to provide a spectrometer device and a spectrometer system which is robust against the granularity of an object, particularly by providing sensor signals that may be combined to a common measurand, particularly a spectrum.

### SUMMARY

This problem is solved by a spectrometer device and a spectrometer system having the features of the independent claims. Advantageous embodiments which might be implemented in an isolated fashion or in any arbitrary combinations are listed in the dependent claims as well as throughout the specification.

In a first aspect of the present invention, a spectrometer device for detecting incident radiation generated by an object is described. The spectrometer device is comprising:
a measurement window configured for accepting incident radiation generated by an object to enter the spectrometer device;
a detector array comprising at least two pixelated sensors each having a field of view designed for accepting at least a portion of the incident radiation, wherein each pixelated sensor is configured for generating at least one detector signal related to the accepted incident radiation;
an optical filter, wherein the optical filter is arranged within the field of views of the at least two pixelated sensors, wherein the optical filter is configured for generating a spectrum of at least two separated wavelength signals from the incident radiation and transmitting the at least two separated wavelength signals onto the respective at least one pixelated sensor;
at least one optical element configured for modifying the field of view of at least one pixelated sensor by increasing at least one overlap between the field of views of the at least two pixelated sensors.

The term “spectrometer device” as used herein is a broad term and is to be given its ordinary and customary meaning to a person of ordinary skill in the art and is not to be limited to a special or customized meaning. The term specifically may refer, without limitation, to an apparatus which is capable of recording the signal intensity with respect to a corresponding wavelength of a spectrum or a partition thereof, such as a wavelength interval, wherein the signal intensity may, preferably, be provided as a sensor signal, particularly at least one of an electrical signal or an optical signal, which may be used for further evaluation. In the spectrometer device according to the present invention, an optical filter may be used for separating incident radiation into a spectrum of separated wavelength signals whose respective intensities are determined by employing a detector array as described below in more detail.

The term “radiation” as used herein is a broad term and is to be given its ordinary and customary meaning to a person of ordinary skill in the art and is not to be limited to a special or customized meaning. The term specifically may refer, without limitation, to waves and/or particles that carry energy. The radiation may be electromagnetic radiation. Electromagnetic radiation may be formed by at least one electromagnetic field wave. The electromagnetic radiation may be selected from at least one of: radio waves; microwaves; infrared; visible light; ultraviolet; X-rays; or gamma rays. Specifically, the electromagnetic radiation may be light. Light may be electromagnetic radiation that may be perceivable by the human eye. Visible light may, usually, be defined as having a wavelength in a range of 380 to 760 nm, between the infrared and the ultraviolet. Infrared light may, usually, be defined as having a wavelength in a range above 760 nm to 1 mm.

The term “object” as used herein is a broad term and is to be given its ordinary and customary meaning to a person of ordinary skill in the art and is not to be limited to a special or customized meaning. The term specifically may refer, without limitation, to an arbitrary body that may be a living object and/or a non-living object. Thus, as an example, the at least one object may comprise one or more constituents and/or one or more parts of a constituent, wherein the at least one constituent or the at least one part thereof may comprise at least one component which may provide a spectrum suitable for investigations. Additionally or alternatively, the object may be or may comprise one or more living beings and/or one or more parts thereof, such as one or more body parts of a human being, e.g. a person or an animal, especially a portion of the human or animal skin. Additionally or alternatively, the object may be a granular object, specifically wherein the granular object comprises at least one of: grains; milled seeds; silage; shredded plastics; or food. Thereby, the object may be a mixture of separable constituents. Alternatively or in addition, the object may have an internal structure, particularly wherein the object may be selected from at least one of wood, concrete, or sausage.

The term “measurement window” refers to a contact surface and/or lay-on-surface for the object to be investigated. The object to be investigated may be placed against the measurement window before the process of measuring the spectrum may be started. During the measurement process the object may remain against the measurement window, particularly until the measurement process may be completed. Thereby, the measurement conditions, specifically a distance and/or an orientation between the spectrometer device and the object may be defined. The measurement window may allow the incident radiation to transfer into the spectrometer device and, particularly, onto the optical filter. The measurement window may be transparent to the incident radiation.

The term “accepting incident radiation” or any arbitrary grammatical variations thereof as used herein is a broad term and is to be given its ordinary and customary meaning to a person of ordinary skill in the art and is not to be limited to a special or customized meaning. The term specifically may refer, without limitation, to allowing the incident radiation to enter the spectrometer device. The incident radiation may, thereby, transfer, particularly transmit, through the measurement window into the spectrometer device.

The term “detector array” as used herein is a broad term and is to be given its ordinary and customary meaning to a person of ordinary skill in the art and is not to be limited to a special or customized meaning. The term specifically may refer, without limitation, to a series of optical sensors which may, preferably, be arranged in a single line as a one-dimensional matrix along the length of the length variable filter or in more than one line, especially in two, three, or four parallel lines, in form of a two-dimensional matrix, in particular, in order to receive most of the intensity of the incident light as possible. Thus, a number N of pixels in one direction may be higher compared to a number M of pixels in a further direction such that the one-dimensional 1×N matrix or a rectangular two-dimensional M×N matrix may be obtained, wherein M<10 and N≥10, preferably N≥20, more preferred N≥50. In addition, the matrixes used herein may also be placed in a staggered arrangement. Herein, each of the optical sensors as used therein may have the same or, within a tolerance level, a similar optical sensitivity, especially for ease of manufacturing the series of the optical sensors. Alternatively, each of the optical sensors as used in the series of the optical sensors may exhibit a varying optical sensitivity that may vary in accordance with the varying transmittance properties of the length variable filter, such as by providing an increasing variation or a decreasing variation of the optical sensitivity with wavelength along the series of the optical sensors. However, other kinds of arrangements may also be feasible. The detector array may be arranged within a housing of the spectrometer device.

The term “pixelated sensor” as used herein is a broad term and is to be given its ordinary and customary meaning to a person of ordinary skill in the art and is not to be limited to a special or customized meaning. The term specifically may refer, without limitation, to a detector designed to generate sensor signals, preferably at least one of electronic or optical signals, associated with the intensity of the incident radiation which impinges on the individual pixelated sensor. The sensor signal may be an analogue and/or a digital signal. The electronic signals for adjacent pixelated sensors can, accordingly, be generated simultaneously or else in a temporally successive manner. By way of example, during a row scan or line scan, it may be possible to generate a sequence of electronic signals which correspond to the series of the individual pixel sensors which are arranged in a line. In addition, the individual pixel sensors may, preferably, be active pixel sensors which may be adapted to amplify the electronic signals prior to providing it to the external evaluation unit. For this purpose, the pixelated sensor may comprise one or more signal processing devices, such as one or more filters and/or analogue-digital-converters for processing and/or preprocessing the electronic signals.

The term “field of view” as used herein is a broad term and is to be given its ordinary and customary meaning to a person of ordinary skill in the art and is not to be limited to a special or customized meaning. The term specifically may refer, without limitation, to a geometrical extent of the observable world that can be viewed by the respective sensor. In particular, the field of view of the optical measurement device corresponds to a solid angle under which the respective sensor is sensitive to radiation generated by the at least one object or a portion thereof. Radiation that may be generated within the field of view of a respective sensor may be incident into the spectrometer device, may be capable of generating at least one detector signal in at least one of the sensors and may, thus, be detected by this sensor.

The term “optical filter” as used herein is a broad term and is to be given its ordinary and customary meaning to a person of ordinary skill in the art and is not to be limited to a special or customized meaning. The term specifically may refer, without limitation, to a filter that modifies and/or selects the incident radiation depending on at least one criterion, specifically a wavelength, a polarization state and/or a direction of incidence radiation. The transfer function of the optical filter may depend on the at least one certain criterion. Particularly, the propagation direction of the incident radiation being transferred by the optical filter may depend on the at least one criterion, particularly wherein other properties of the incident radiation may remain unchanged as far as possible at the same time. The optical filter may generate a spectrum of the incident radiation, particularly by separating the incident radiation into at least two different wavelength signals. The at least two different wavelength signals may be transferred onto different pixelated sensors, whereby the pixelated sensors may detect the respective wavelength signal that is incident on the pixelated sensor and/or may generate a corresponding sensor signal. The optical filter may be arranged within a housing of the spectrometer device. The term “spectrum” as used herein is a broad term and is to be given its ordinary and customary meaning to a person of ordinary skill in the art and is not to be limited to a special or customized meaning. The term specifically may refer, without limitation, to a partition of an optical spectral range, particularly of the incident radiation. Each partition of the spectrum, specifically each wavelength signal of the at least two different wavelength signals, may be constituted by an optical signal, which may be defined by a signal wavelength and the corresponding signal intensity.

The term “optical element” as used herein is a broad term and is to be given its ordinary and customary meaning to a person of ordinary skill in the art and is not to be limited to a special or customized meaning. The term specifically may refer, without limitation, to an element that exerts an influence on the incident radiation in a manner that it influences the direction of propagation of at least a portion of the incident radiation. The optical element may influence the direction in a manner that may increase the optical path length between the measurement window and the detector array. The optical element may, thereby, influence at least one field of view of at least one sensor. The optical element may be arranged within a housing of the spectrometer device. The term “modifying” or any arbitrary grammatical variations thereof as used herein is a broad term and is to be given its ordinary and customary meaning to a person of ordinary skill in the art and is not to be limited to a special or customized meaning. The term specifically may refer, without limitation, to adjusting at least one field of view by acting on the incident radiation, particularly by redirecting at least a portion of the incident radiation. The term “increasing at least one overlap between the field of views” or any arbitrary grammatical variations thereof as used herein is a broad term and is to be given its ordinary and customary meaning to a person of ordinary skill in the art and is not to be limited to a special or customized meaning. The term specifically may refer, without limitation, to enlarging an absolute amount and/or a ratio of a three-dimensional space that is simultaneously or concurrently covered by the field of views of the at least two pixelated sensors, particularly in the measurement window and/or directly behind the measurement window, wherein the term “behind” refers to the propagation direction of the incident radiation with respect to the measurement window. The at least one optical element may be configured for modifying the field of view of each pixelated sensor of the at least two pixelated sensors for increasing the at least one overlap between the field of views, particularly in the same manner.

Increasing the at least one overlap between the field of views of the at least two pixelated sensors may result in at least one increased overlap area comprising measurement spots for each field of view of the at least two pixelated sensors on the measurement window. The term “measurement spot” as used herein is a broad term and is to be given its ordinary and customary meaning to a person of ordinary skill in the art and is not to be limited to a special or customized meaning. The term specifically may refer, without limitation, to a surface generated by the field of view that is located on the measurement window from which the radiation may be detected by the respective pixelated sensor.

The optical filter may be selected from or may comprise at least one of:
a length variable filter;
a static filter;
a tunable filter, particularly a MEMS Fabry-Perot cavity;
an optical lens; or
a diffractive element.
   The optical filter may be selected from or may comprise further components as described below.

The term “length variable filter” as used herein is a broad term and is to be given its ordinary and customary meaning to a person of ordinary skill in the art and is not to be limited to a special or customized meaning. The term specifically may refer, without limitation, to an optical filter which comprises a plurality of individual filter elements, preferably a plurality of interference filter elements, which may, in particular, be provided in a continuous arrangement of the individual filter elements. Herein, each of the filter elements may form a bandpass with a variable center wavelength for each spatial position on the filter, preferably continuously, along a single dimension, which is, usually, denoted by the term “length”, on a receiving surface of the length variable filter. The variable center wavelength may be a linear function of the spatial position of each filter element, in which case the length variable filter is usually referred to as a “linearly variable filter” or by its abbreviation “LVF”. However, other kinds of functions may be applicable to the relationship between the variable center wavelength and the spatial position on the individual filter elements. Herein, the individual filter elements may be located on a transparent substrate which may, in particular, comprise at least one material that may show a high degree of optical transparency within in the infrared (IR) spectral range, especially, within the near-infrared (NIR) spectral range as described below in more detail, whereby varying spectral properties, especially continuously varying spectral properties, of the filter along length of the filter may be achieved. In particular, the length variable filter may be a wedge filter that may be adapted to carry at least one response coating on a transparent substrate, wherein the response coating may exhibit a spatially variable property, in particular, a spatially variable thickness. However, other kinds of length variable filters which may comprise other materials or which may exhibit a further spatially variable property may also be feasible. At a normal angle of incidence of an incident light beam, each of the filter elements as comprised by the length variable filter may have a bandpass width that may amount to a fraction of the center wavelength, typically to a few percent, of the particular filter.

The term “static filter” as used herein is a broad term and is to be given its ordinary and customary meaning to a person of ordinary skill in the art and is not to be limited to a special or customized meaning. The term specifically may refer, without limitation, to an optical filter, particularly a bandpass filter, which blocks and/or selects light of a predetermined wavelength range, specifically by reflecting and/or absorbing. The wavelength range may be fixed. A fixed wavelength length may be unchangeable and/or static. The optical properties of the static filter may not be time-varying.

The term “tunable filter” as used herein is a broad term and is to be given its ordinary and customary meaning to a person of ordinary skill in the art and is not to be limited to a special or customized meaning. The term specifically may refer, without limitation, to an optical filter which blocks and/or selects light of an adjustable wavelength range. The optical properties of the tunable filter may be time-varying. An interferometer may be used as a tunable filter, specifically a Fabry-Perot interferometer, Mach-Zehnder interferometer and/or a Michelson interferometer. Alternatively, angle-dependent wavelength shifts of a static filter may be utilized. This may be realized by using at least one micro electro mechanical system, MEMS, where moving parts of the interferometer are realized be using micro actuators.

The term “optical lens” as used herein is a broad term and is to be given its ordinary and customary meaning to a person of ordinary skill in the art and is not to be limited to a special or customized meaning. The term specifically may refer, without limitation, to a transparent unit, particularly an item, wherein at least one surface of the object is curved, particularly in a spherical manner. Incident radiation may be refracted at the at least one surface of the optical lens, particularly depending on the wavelength of the incident radiation. The incident radiation may be deflected by a converging optical lens to a center of the beam generated by the incident radiation. Alternatively, the incident radiation may be deflected outwardly of the beam by a diverging optical lens. An optical lens may have a convex surface for collecting and/or a concave surface for dispersing the incident radiation.

The term “diffractive element” as used herein is a broad term and is to be given its ordinary and customary meaning to a person of ordinary skill in the art and is not to be limited to a special or customized meaning. The term specifically may refer, without limitation, to an item for shaping the incident radiation by diffraction of the incident radiation at an optical grating.

The length variable filter may comprise at least two bandpass filters, wherein each bandpass filter may be assigned to a respective pixelated sensor by being arranged within the field of view of the respective pixelated sensor, wherein each bandpass filter may be configured for selecting at least one wavelength of the accepted incident radiation. The term “bandpass filter” as used herein is a broad term and is to be given its ordinary and customary meaning to a person of ordinary skill in the art and is not to be limited to a special or customized meaning. The term specifically may refer, without limitation, to an optical filter that allows only incident radiation having a wavelength that is within a predefined range to pass. Incident radiation having a wavelength below and/or above the predefined range may be blocked or may be significantly attenuated. The selected at least one wavelength may be within the predefined range. The selected at least one wavelength may be transferred onto the respective pixelated sensor. The term “assigned to a respective pixelated sensor” as used herein is a broad term and is to be given its ordinary and customary meaning to a person of ordinary skill in the art and is not to be limited to a special or customized meaning. The term specifically may refer, without limitation, to transmitting the accepted incident radiation onto the respective pixelated sensor. Thereby, the at least two bandpass filters may be arranged in a manner that each bandpass filter of the at least two bandpass filters is placed within a field of view of a different pixelated sensor.

A ratio between the at least one overlap area generated by the measurement spots of each field of view of the at least two pixelated sensors and a combined area generated by the measurement spots of each field of view of the at least two pixelated sensors on the measurement window may be at least 60 %, 70 %, 80 % or 90 %. The term “overlap area” as used herein is a broad term and is to be given its ordinary and customary meaning to a person of ordinary skill in the art and is not to be limited to a special or customized meaning. The term specifically may refer, without limitation, to an area on the measurement window that is generated by an intersection of each measurement spot of the at least two pixelated sensors.

The entire overlap area may comprise at least a portion of each measurement spot. The term “combined area” as used herein is a broad term and is to be given its ordinary and customary meaning to a person of ordinary skill in the art and is not to be limited to a special or customized meaning. The term specifically may refer, without limitation, to an area on the measurement window that is generated by an accumulation of each field of view of the at least two pixelated sensors. The combined area comprises each measurement spot of the at least two pixelated sensors.

Each field of view may be conical, particularly wherein each field of view may have a Full Width Half Maximum, FWHM, opening angle γ of less than 60°, 40° or 20°. A conical field of view may generate a round or elliptical measurement spot. Further forms may be possible, for a measurement spot and/or a field of view. Exemplarily, a generated measurement spot may be quadratic or rectangular. The opening angle y may be an interior angle having its vertex at an origin of the field of view.

A further ratio between a distance between two chief rays of the field of views of the least two adjacent pixelated sensors of the at least two pixelated sensors on the measurement window and a width of the measurement spots of each field of view of at least two adjacent pixelated sensors may be below 35%, 25 %, 15 %, 10 %, 8% or 5%. This may particularly hold, in case the field of views of at least two adjacent pixelated sensors may generate round measurement spots, wherein the width of the measurement spots may be identical. The term “chief ray” as used herein is a broad term and is to be given its ordinary and customary meaning to a person of ordinary skill in the art and is not to be limited to a special or customized meaning. The term specifically may refer, without limitation, to a center axis of a field of view. Alternatively or in addition, the chief ray may be a symmetry axis of the field of view. Alternatively or in addition, the chief ray may originate at the origin of the field of view and intersect a center point of the measurement spot. The term “width” as used herein is a broad term and is to be given its ordinary and customary meaning to a person of ordinary skill in the art and is not to be limited to a special or customized meaning. The term specifically may refer, without limitation, to a distance of the center point of the measurement spot to a periphery of the measurement spot.

The width may be the diameter of the measurement spot.

A detectable wavelength range of the incident radiation may be ranging from at least one of:
from 400 nm to 10 μm, specifically from 400 nm to 1 μm;
from 900 nm to 3 μm, specifically wherein the at least two pixelated sensors are PbS sensors; or
from 600 nm to 5 μm, specifically wherein the at least two pixelated sensors are PbSe sensors.

The term “detectable range” as used herein is a broad term and is to be given its ordinary and customary meaning to a person of ordinary skill in the art and is not to be limited to a special or customized meaning. The term specifically may refer, without limitation, to a range of wavelengths of the incident radiation that is capable of generating at least one detector signal when impinging on the pixelated sensor. Incident radiation having a wavelength that is below the detectable wavelength or above the detectable wavelength range may not be detectable and may, thereby, not generate a detector signal when the incident radiation is impinging on the pixelated sensor.

The at least two pixelated sensors may be arranged on a detector plane next to each other, particularly wherein the detector plane may be a flat plane. The term “detector plane” as used herein is a broad term and is to be given its ordinary and customary meaning to a person of ordinary skill in the art and is not to be limited to a special or customized meaning. The term specifically may refer, without limitation, to an extended, particularly flat, two-dimensional abstract object or concrete object on which the pixelated sensors are arranged. The detector plane may be formed by the at least two pixelated sensors. No further element except of the at least two pixelated sensors may be required to generate the plane. Alternatively or in addition, at least one further element may be comprised by the detector plane. The at least two pixelated sensors may be arranged on the at least one further element. The at least two pixelated sensors may be arranged in a line. Thereby, the at least two pixelated sensors may be arranged one after the other in a single direction. The measurement window may be parallel to the detector plane.

The at least two bandpass filters may be arranged on a filter surface. Alternatively or in addition, the at least two bandpass filters may be arranged on the filter surface in a line. The filter surface may be curved. The term “filter surface” as used herein is a broad term and is to be given its ordinary and customary meaning to a person of ordinary skill in the art and is not to be limited to a special or customized meaning. The term specifically may refer, without limitation, to an extended, particularly curved, two-dimensional abstract object or concrete object on which the bandpass filters are arranged. The filter surface may be formed by the at least two bandpass filters. No further element except of the at least two bandpass filters may be required to generate the filter surface. Alternatively or in addition, at least one further element may be comprised by the filter surface, particularly the at least two bandpass filters may be arranged on the at least one further element. The at least two bandpass filters may be arranged in a line. Thereby, the at least two pixelated sensors may be arranged one after the other in one direction. The measurement window may be parallel to the filter surface. The detector plane may be parallel to the filter surface.

At least one bandpass filter may be aligned to a respective pixelated sensor with regard to a respective field of view of the respective pixelated sensor, particularly to the chief ray of the field of view of the respective pixelated sensor. The term “aligned” as used herein is a broad term and is to be given its ordinary and customary meaning to a person of ordinary skill in the art and is not to be limited to a special or customized meaning. The term specifically may refer, without limitation, to the at least one bandpass filter being arranged within the field of view, particularly the at least one chief ray of the field of view intersecting the at least one bandpass filter.

An optical path length between the measurement window and the detector plane may be 50 μm to 30 cm, 100 μm to 50 mm or 500 μm to 15 mm. The term “optical path length” as used herein is a broad term and is to be given its ordinary and customary meaning to a person of ordinary skill in the art and is not to be limited to a special or customized meaning. The term specifically may refer, without limitation, to a distance that the incident radiation propagates within the spectrometer device, taking into account, in particular, the at least one optical element. The optical path length may be longer than the geometrical path length by a factor of between 1 and 5.

The field of view of a first pixelated sensor of the at least two pixelated sensors may be tilted in respect to a field of view of a second pixelated sensor of the at least two pixelated sensors due to the modification of the field of view of at least one pixelated sensor by the at least one optical element. By tilting the respective field of views, the respective chief rays may be tilted, particularly at the measurement window. The term “tilting” or any arbitrary grammatical variations thereof, particularly the term “tilted”, as used herein is a broad term and is to be given its ordinary and customary meaning to a person of ordinary skill in the art and is not to be limited to a special or customized meaning. The term specifically may refer, without limitation, to having a different orientation. The pixelated sensors may be considered as tilted, when the chief ray of the field of view of the first pixelated sensor is pointing in a different direction than the chief ray of the field of view of the second pixelated sensor, particularly in the measurement window or directly behind the measurement window. In case the chief ray of the field of view of the first pixelated sensor may be pointing in a different direction than the chief ray of the field of view of the second pixelated sensor, the respective chief rays may be pointing in different directions in the measurement window or directly behind the measurement window.

The at least one optical element may comprise at least one aperture for trimming the field of view of at least one pixelated sensor, particularly and thereby aligning the chief ray of the field of view of at least one pixelated sensor, particularly aligning the chief ray towards a center of the at least one overlap area. The term “trimming” or any arbitrary grammatical variations thereof as used herein is a broad term and is to be given its ordinary and customary meaning to a person of ordinary skill in the art and is not to be limited to a special or customized meaning. The term specifically may refer, without limitation, to modifying something in order to bring it into a desired shape. Exemplarily, a field of view may be constricted and/or narrowed by blocking a part of the incident radiation, particularly by using the aperture. The term “aperture” as used herein is a broad term and is to be given its ordinary and customary meaning to a person of ordinary skill in the art and is not to be limited to a special or customized meaning. The term specifically may refer, without limitation, to an optical unit that is configured to limit the cross-section of a beam and/or a field of view, particularly a beam generated be the accepted incident radiation.

The at least one optical element may comprise at least one further aperture for trimming the field of view of at least one further pixelated sensor, particularly and thereby aligning a further chief ray of the field of view of the at least one further pixelated sensor, particularly towards the center of the at least one overlap area. An angle a between the chief ray and the further chief ray at the measurement window may be above 0°, 5°, 10°, 20°, 40°or 60°.

Each bandpass filter may have an acceptance angle, wherein at least one or each bandpass filter may be arranged in a manner having a respective chief ray of a field of view impinging on the respective bandpass filter within the acceptance angle. The term “acceptance angle” as used herein is a broad term and is to be given its ordinary and customary meaning to a person of ordinary skill in the art and is not to be limited to a special or customized meaning. The term specifically may refer, without limitation, to a predefined angle by which a chief ray may maximally intersect the bandpass filter for allowing an optimal performance of the bandpass filter. Particularly, an offset between the incident radiation generated by the bandpass filter may be within an acceptable range, particularly in case the chief ray intersects the bandpass at an angle that is smaller than the acceptance angle. Alternatively or in addition, a shift of the wavelength of the incident radiation generated by the bandpass filter may be within an acceptable range, particularly in case the chief ray intersects the bandpass at an angle that is smaller than the acceptance angle. A center axis of a cone defined by the acceptance angle of the at least one or each bandpass filter may be parallel to a respective chief ray intersecting with the respective optical filter. A receiving surface of each bandpass filter may define a normal orientation, wherein at least one or each bandpass filter may be arranged in a manner having a respective chief ray of a field of view impinging on the receiving surface of the respective bandpass filter being parallel to the normal orientation. The optical filter may comprise a curved filter surface, particularly wherein the at least two bandpass filters may be arranged on the curved filter surface.

The at least one optical element may comprise at least one mirror, particularly a flat mirror or an imaging mirror. The term “mirror” as used herein is a broad term and is to be given its ordinary and customary meaning to a person of ordinary skill in the art and is not to be limited to a special or customized meaning. The term specifically may refer, without limitation, to an optical unit having a reflective surface for reflecting at least a portion of radiation impinging on the reflective surface, particularly at least a portion of the incident radiation. A typical mirror may reflect at least 5 % of the radiation that is incident on the mirror. Further typically a mirror may, preferably, reflect at least 50% or, more preferably, at least 90% of the radiation that is incident on the mirror. A mirror may have a type selected from at least one of: a dielectric mirror, particularly a distributed Bragg mirror; or a metalized mirror, particularly metalized with gold, silver and/or aluminum. Substrates of a mirror may comprise at least one inorganic material and/or at least one organic material, particularly plastic and/or glass.

The term “flat mirror” as used herein is a broad term and is to be given its ordinary and customary meaning to a person of ordinary skill in the art and is not to be limited to a special or customized meaning. The term specifically may refer, without limitation, to a mirror having a planar reflecting surface. The flat mirror may reflect the incident radiation in a manner that the direction of the reflected incident radiation does not depend on a position of the flat mirror at which the incident radiation is incident on the flat mirror. A width of a beam generated by the incident radiation may remain constant when the incident radiation is reflected by the flat mirror. The flat mirror may have a flat reflecting surface.

The term “imaging mirror” as used herein is a broad term and is to be given its ordinary and customary meaning to a person of ordinary skill in the art and is not to be limited to a special or customized meaning. The term specifically may refer, without limitation, to a mirror having a reflecting surface that is formed in a manner that the incident radiation and/or the field of view of the at least one pixelated sensor is focused on at least one focusing point provided by the imaging mirror. The field of view of the at least one pixelated sensor may be focused at the measurement window. Thereby, the field of view may be narrowed at the measurement window. Therefore, the imaging mirror may reflect the incident radiation in a manner that the direction of the reflected incident radiation depends on a position of the imaging mirror at which the incident radiation impinges the flat mirror. The imaging mirror may be a concave mirror.

The imaging mirror may be selected from at least one of:
a curved mirror;
a free form mirror.

The term “curved mirror” as used herein is a broad term and is to be given its ordinary and customary meaning to a person of ordinary skill in the art and is not to be limited to a special or customized meaning. The term specifically may refer, without limitation, to a mirror having a curved reflecting surface. The curved mirror may have an at least partially curved reflecting surface, specifically an at least partially concave reflecting surface. The term “free form mirror” as used herein is a broad term and is to be given its ordinary and customary meaning to a person of ordinary skill in the art and is not to be limited to a special or customized meaning. The term specifically may refer, without limitation, to a mirror having a surface that is capable of being described by using a polynomial function.

The field of view of at least one pixelated sensor may be folded by increasing the optical path length between the detector array and the measurement window due to the modification of the field of view of the at least one pixelated sensor by the at least one optical element. The term “folding” or any arbitrary grammatical variations thereof, particularly “folded”, as used herein is a broad term and is to be given its ordinary and customary meaning to a person of ordinary skill in the art and is not to be limited to a special or customized meaning. The term specifically may refer, without limitation, to guiding the incident radiation in a manner that a length of the optical path on which the incident radiation propagates from the measurement window to the at least one pixelated sensor, particularly inside of the spectrometer device, specifically inside a housing of the spectrometer device, is increased by using the optical element. The length of the optical path may, particularly, be increased relative to a length of the optical path on which the incident radiation propagates from the measurement window to the at least one pixelated sensor in case no optical element is present. The field of view of the at least one pixelated sensor may be folded by modifying the direction of a chief ray of a respective field of view to have a directional component that is parallel to the detector array, particularly wherein an angle between the detector array and the direction of the chief ray may be smaller than 0°, 20°, 40°, 60°or 80°, more particularly wherein the directional component may account for at least 50%, 60%, 70%, 80%, 90% or 100% of the direction of the chief ray. The term “directional component” as used herein is a broad term and is to be given its ordinary and customary meaning to a person of ordinary skill in the art and is not to be limited to a special or customized meaning. The term specifically may refer, without limitation, to a vector that is pointing in a direction parallel to an extension of the detector array.

The at least one optical element may focus the field of view of the at least one pixelated sensor, particularly on the measurement window, more particularly on the at least one overlap area. The focusing may be generated by the modification of the field of view of the at least one pixelated sensor by the at least one optical element. The term “focusing” or any arbitrary grammatical variations thereof as used herein is a broad term and is to be given its ordinary and customary meaning to a person of ordinary skill in the art and is not to be limited to a special or customized meaning. The term specifically may refer, without limitation, to narrowing a width of the respective field of view. The at least one optical element may comprise at least one imaging mirror for focusing the respective field of view. This imaging mirror may be arranged within the respective field of view.

A chief ray of the field of view of the at least one pixelated sensor may be redirected due to the modification of the field of view of the at least one pixelated sensor by the at least one optical element, particularly redirected towards a chief ray of a further field of view of a further pixelated sensor of the at least two pixelated sensors, more particularly redirected towards a center of the at least one overlap area. The term “redirecting” or any arbitrary grammatical variations thereof as used herein is a broad term and is to be given its ordinary and customary meaning to a person of ordinary skill in the art and is not to be limited to a special or customized meaning.

The term specifically may refer, without limitation, to modifying a direction of the respective chief ray. The at least one optical element may comprise at least one imaging mirror for redirecting the respective field of view. This imaging mirror may be arranged within the respective field of view. Alternatively or in addition, the at least one optical element may comprise at least one flat mirror for redirecting the respective field of view. This flat mirror may be arranged within the respective field of view.

The at least one optical element comprises a first mirror selected from at least one of:
a first flat mirror; or
a first imaging mirror,
   and wherein the at least one optical element comprises a second mirror selected from at least one of:
a second flat mirror; or
a second imaging mirror, and
   particularly wherein the at least one optical element may comprise a further mirror, particularly selected from at least one of:
a further flat mirror; or
a further imaging mirror.

Thereby, the following combinations may be possible: a first flat mirror and a second flat mirror; a first imaging mirror and a second flat mirror; a first flat mirror and a second imaging mirror; a first imaging mirror and a second imaging mirror; a first flat mirror and a second flat mirror and a further flat mirror; a first imaging mirror and a second flat mirror and a further flat mirror; a first flat mirror and a second imaging mirror and a further flat mirror; a first imaging mirror and a second imaging mirror and a further flat mirror; a first flat mirror and a second flat mirror and a further imaging mirror; a first imaging mirror and a second flat mirror and a further imaging mirror; a first flat mirror and a second imaging mirror and a further imaging mirror; a first imaging mirror and a second imaging mirror and a further imaging mirror. Further combinations may also be possible.

The at least one optical element may comprise a first flat mirror and a second flat mirror, wherein the first flat mirror may be arranged in a direction of incidence of the incident radiation in front of the second flat mirror. The arrangement of the first flat mirror and the second flat mirror may increase the at least one overlap area comprising the measurement spots of each field of view of the at least two pixelated sensors on the measurement window. The arrangement of the first flat mirror and the second flat mirror may be folding at least one or each field of view by increasing the optical path length between the detector array and the measurement window. The first flat mirror may reflect the incident radiation towards or onto the second flat mirror, wherein the second flat mirror may reflect the incident radiation towards or onto the optical filter. The reflecting surface of the first flat mirror and the reflecting surface of the second flat mirror may be parallel.

The at least one optical element may comprise a first flat mirror and a second imaging mirror, wherein the first flat mirror may be arranged in a direction of incidence of the incident radiation in front of the second imaging mirror. The arrangement of the first flat mirror and the second imaging mirror may increase the at least one overlap area comprising the measurement spots of each field of view of the at least two pixelated sensors on the measurement window. The arrangement of the first flat mirror and the second imaging mirror may be folding at least one or each field of view by increasing the optical path length between the detector array and the measurement window. The first flat mirror may reflect the incident radiation towards or onto the second imaging mirror, wherein the second imaging mirror may reflect the incident radiation towards or onto the optical filter. The second imaging mirror may be focusing the field of views of the at least two pixelated sensors at the measurement window. Alternatively or in addition, the at least one chief ray of the field of views of the at least two pixelated sensors may be directed towards a center of the at least one overlap area at the measurement window by the second imaging mirror.

The at least one optical element may comprise a first imaging mirror and a second flat mirror, wherein the first imaging mirror may be arranged in a direction of incidence of the incident radiation in front of the second flat mirror. The arrangement of the first imaging mirror and the second flat mirror may increases the at least one overlap area comprising the measurement spots of each field of view of the at least two pixelated sensors on the measurement window.

The arrangement of the first imaging mirror and the second flat mirror may be folding at least one or each field of view by increasing the optical path length between the detector array and the measurement window. The first imaging mirror may reflect the incident radiation towards or onto the second flat mirror, wherein the second flat mirror may reflect the incident radiation towards or onto the optical filter. The first imaging mirror may be focusing the field of views of the at least two pixelated sensors at the measurement window. Alternatively or in addition, at least one or each chief rays of the field of views of the at least two pixelated sensors may be directed towards a center of the at least one overlap area at the measurement window by the first imaging mirror.

The at least one optical element may comprise a first imaging mirror and a second imaging mirror, wherein the first imaging mirror may be arranged in a direction of incidence of the incident radiation in front of the second imaging mirror. The arrangement of the first imaging mirror and the second imaging mirror may increase the at least one overlap area comprising the measurement spots of each field of view of the at least two pixelated sensors on the measurement window. The arrangement of the first imaging mirror and the second imaging mirror may be folding at least one or each field of view by increasing the optical path length between the detector array and the measurement window. The first imaging mirror may reflect the incident radiation towards or onto the second imaging mirror, wherein the second imaging mirror may reflect the incident radiation towards or onto the optical filter. The first imaging mirror and the second imaging mirror may be focusing the field of views of the at least two pixelated sensors at the measurement window. Alternatively or in addition, at least one or each chief ray of the field of views of the at least two pixelated sensors may be directed towards a center of the at least one overlap area at the measurement window by the first imaging mirror and the second imaging mirror.

The at least one optical element may comprise a further imaging mirror. The further imaging mirror may reflect the incident radiation from the second flat mirror towards or onto the optical filter. The first imaging mirror may reflect the incident radiation towards or onto the second imaging mirror, wherein the second imaging mirror may reflect the incident radiation towards or onto the further imaging mirror, wherein the further imaging mirror may reflects the incident radiation towards or onto the optical filter. The further imaging mirror may be further focusing the field of views of the at least two pixelated sensors at the measurement window. Alternatively or in addition, the at least one or each chief ray of the field of views of the at least two pixelated sensors may be further directed towards the center of the at least one overlap area window by the further imaging mirror.

The at least one optical element may increases the optical path length of the incident radiation from the measurement window to the detector array by at least 50 μm to 30 cm, 100 μm to 50 mm or 500 μm to 15 mm. The optical path length between the first mirror and the second mirror may be at least 50 μm to 30 cm, 100 μm to 50 mm or 500 μm to 15 mm. The optical path length between the second mirror and the further mirror may be at least 50 μm to 30 cm, 100 μm to 50 mm or 500 μm to 15 mm.

The detector array may comprise at least two further pixelated sensors, wherein the at least one optical element may be configured for generating at least one further overlap between the field of views of the at least two further pixelated sensors at the measurement window, particularly at least one further overlap area comprising further measurement spots of each further field of view of the at least two further pixelated sensors. The further overlap area may not intersected with any other overlap area.

The spectrometer device may comprise at least one radiation emitting element, wherein the at least one radiation emitting element may be configured for emitting optical radiation. The at least one radiation emitting element may be part of the spectrometer device in a housing. Alternatively or additionally, the at least one radiation emitting element may also be arranged outside a housing, e.g. as a separate radiation emitting element. The at least one radiation emitting element may be configured to provide sufficient emission in a desired spectral range.

The at least one radiation emitting element may, in particular, be comprised by at least one of a thermal radiator or a semiconductor-based radiation source. Herein, the semiconductor-based radiation source may, especially, be selected from at least one of a light emitting diode (LED) or a laser, in particular a laser diode.

The thermal radiator may be selected from an incandescent lamp or a thermal infrared emitter. The term “incandescent lamp” as used herein is a broad term and is to be given its ordinary and customary meaning to a person of ordinary skill in the art and is not to be limited to a special or customized meaning. The term specifically may refer, without limitation, to an electric light having a heatable element, such as a wire filament heated, which is capable of being heated to a temperature at which it emits light, especially infrared light. Since the incandescent lamp can, therefore, be considered as a thermal emitter within the infrared spectral range, an emission power of the incandescent lamp decreases with increasing wavelength. The thermal radiator may be selected from an incandescent lamp or a thermal infrared emitter. The term “thermal infrared emitter” as used herein is a broad term and is to be given its ordinary and customary meaning to a person of ordinary skill in the art and is not to be limited to a special or customized meaning. The term specifically may refer, without limitation, to a micro-machined thermally emitting device which comprises a radiation emitting surface as the radiation emitting element that emits the optical radiation to be monitored.

In a further aspect of the present invention, a spectrometer system is described. The spectrometer device is comprising
a spectrometer device for detecting incident radiation generated by an object according to any one of the preceding claims; and
an evaluation device configured for determining information related to a spectrum of the object by evaluating at least one detector signal provided by the spectrometer device.

The term “evaluation device” as used herein is a broad term and is to be given its ordinary and customary meaning to a person of ordinary skill in the art and is not to be limited to a special or customized meaning. The term specifically may refer, without limitation, to an arbitrary device designed to generate the at least one desired item of information, in particular related to the spectrum of the object. For this purpose, the evaluation unit may be or may comprise one or more integrated circuits, such as one or more application-specific integrated circuits (ASICs), and/or one or more data processing devices, such as one or more of computers, digital signal processors (DSP), field programmable gate arrays (FPGA) preferably one or more microcomputers and/or microcontrollers, especially comprised by at least one mobile communication device, in particular selected from a smartphone, a tablet or a laptop; however further embodiments may also be feasible. Additional components may be comprised, such as one or more preprocessing devices and/or data acquisition devices, such as one or more devices for receiving and/or preprocessing of the detector signals, such as one or more AD-converters and/or one or more filters. As used herein, the detector signal is provided by the spectrometer device, in particular, by the detector array of the spectrometer device. Further, the evaluation unit may comprise one or more data storage devices. Further, the evaluation unit may comprise one or more interfaces, such as one or more wireless interfaces and/or one or more wire-bound interfaces.

Definitions or characteristics given for the further aspects may also apply to the spectrometer system. Typically, this may further apply to any embodiments and any claim, presented in the below.

The above-described spectrometer device and the spectrometer system have considerable advantages over the prior art. Thus, generally the spectrometer device and the spectrometer system are robust against the granularity of an object, particularly by providing sensor signal that may be correlated in a common measurement result, as the field of views of the single pixelated sensors have an increased overlap, particularly at the measurement window and thereby may measure on the same position of the object, whereby the influences on the optical signals generated by the pixelated sensor each have the same influence due to the granularity of the sample.

Thereby, the influence of the granularity of the object may only affect the overall signal level, particularly as all channels may look at the same spot of the object. However, this may not affect the spectral contrast of the measurement signal. This may be considered analogue to a color measurement in the visible regime, where a color mixture of two components may be brighter or darker, without losing the ratio of both constituents.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. Herein, in most cases, when referring to the respective feature or element, the expressions “at least one” or “one or more” will not be repeated, notwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:

Embodiment 1: A spectrometer device for detecting incident radiation generated by an object comprising:
a measurement window configured for accepting incident radiation generated by an object to enter the spectrometer device;
a detector array comprising at least two pixelated sensors each having a field of view designed for accepting at least a portion of the incident radiation, wherein each pixelated sensor is configured for generating at least one detector signal related to the accepted incident radiation;
an optical filter, wherein the optical filter is arranged within the field of views of the at least two pixelated sensors, wherein the optical filter is configured for generating a spectrum of at least two separated wavelength signals from the incident radiation and transmitting the at least two separated wavelength signal onto the respective at least one pixelated sensor;
at least one optical element configured for modifying the field of view of at least one pixelated sensor by increasing at least one overlap between the field of views of the at least two pixelated sensors.

Embodiment 2: The spectrometer device according to the preceding embodiment, wherein increasing the at least one overlap between the field of views of the at least two pixelated sensors results in an increased at least one overlap area comprising measurement spots of each field of view of the at least two pixelated sensors on the measurement window.

Embodiment 3: The spectrometer device according to anyone of the preceding embodiment, wherein the optical filter is selected from or comprises at least one of:
a length variable filter;
a static filter;
a tunable filter, particularly a MEMS Fabry-Perot cavity;
an optical lens; or
a diffractive element.

Embodiment 4: The spectrometer device according to the preceding embodiment, wherein the length variable filter is comprising at least two bandpass filters, wherein each bandpass filter is assigned to a respective pixelated sensor by being arranged within the field of view of the respective pixelated sensor, wherein each bandpass filter is configured for selecting at least one wavelength of the accepted incident radiation.

Embodiment 5: The spectrometer device according to anyone the preceding embodiment, wherein the at least one optical element is configured for modifying the field of view of each pixelated sensor of the at least two pixelated sensors for increasing the at least one overlap between the field of views.

Embodiment 6: The spectrometer device according to anyone of the four preceding embodiments, wherein a ratio between the at least one overlap area generated by the measurement spots of each field of view of the at least two pixelated sensors and a combined area generated by the measurement spots of each field of view of the at least two pixelated sensors on the measurement window is at least 60 %, 70 %, 80 % or 90 %.

Embodiment 7: The spectrometer device according to anyone of the preceding embodiments, wherein each field of view is conical, particularly wherein each field of view has an Full Width Half Maximum, FWHM, opening angle y of less than 60°, 40°or 20°.

Embodiment 8: The spectrometer device according to anyone of the preceding embodiments, wherein a further ratio between a distance between two chief rays of the field of views of at least two adjacent pixelated sensors of the at least two pixelated sensors on the measurement window and a width of the measurement spots of each field of view of at least two adjacent pixelated sensors is below 35%, 25 %, 15 %, 10 %, 8% or 5%.

Embodiment 9: The spectrometer device according to anyone of the preceding embodiments, wherein a detectable wavelength range of the incident radiation is ranging from at least one of:
from 400 nm to 10 μm, specifically from 400 nm to 1 μm;
from 900 nm to 3 μm, specifically wherein the at least two pixelated sensors are PbS sensors; or
from 600 nm to 5 μm, specifically wherein the at least two pixelated sensors are PbSe sensors.

Embodiment 10: The spectrometer device according to anyone of the preceding embodiments, wherein the at least two pixelated sensors are arranged on a detector plane next to each other, particularly wherein the detector plane is a flat plane.

Embodiment 11: The spectrometer device according to anyone of the preceding embodiments, wherein the at least two pixelated sensors are arranged in a line.

Embodiment 12: The spectrometer device according to anyone of the eight preceding embodiments, wherein the at least two bandpass filters are arranged on a filter surface, particularly wherein the filter surface is curved.

Embodiment 13: The spectrometer device according to the preceding embodiment, wherein the at least two bandpass filters are arranged in a line.

Embodiment 14: The spectrometer device according to anyone of the ten preceding embodiments, wherein each bandpass filter is aligned to a respective pixelated sensor with regard to a respective field of view of the respective pixelated sensor, particularly to the chief ray of the field of view of the respective pixelated sensor.

Embodiment 15: The spectrometer device according to anyone of the three preceding embodiments, wherein the measurement window is parallel to the filter surface.

Embodiment 16: The spectrometer device according to anyone of the six preceding embodiments, wherein the measurement window is parallel to the detector plane.

Embodiment 17: The spectrometer device according to anyone of the seven preceding embodiments, wherein an optical path length between the measurement window and the detector plane is 50 μm to 30 cm, 100 μm to 50 mm or 500 μm to 15 mm.

Embodiment 18: The spectrometer device according to anyone of the preceding embodiments, wherein the field of view of a first pixelated sensor of the at least two pixelated sensors is tilted in respect to a field of view of a second pixelated sensor of the at least two pixelated sensors due to the modification of the field of view of the at least one pixelated sensor by the at least one optical element.

Embodiment 19: The spectrometer device according to anyone of the preceding embodiments, wherein the at least one optical element comprises at least one aperture for trimming the field of view of at least one pixelated sensor, particularly and thereby aligning the chief ray of the field of view of at least one pixelated sensor, particularly towards a center of the at least one overlap area.

Embodiment 20: The spectrometer device according to the two preceding embodiment, wherein an angle a between a chief ray and a further chief ray at the measurement window is above 0°, 5°, 10°, 20°, 40°or 60°, particularly due to the tilting of the field of view of the first pixelated sensor having the chief ray in respect the field of view of the second pixelated sensor having the further chief ray.

Embodiment 21: The spectrometer device according to anyone of the preceding embodiments, wherein each bandpass filter has an acceptance angle, wherein at least one or each bandpass filter is arranged in a manner having a respective chief ray of a field of view impinging on the respective bandpass filter within the acceptance angle.

Embodiment 22: The spectrometer device according to anyone of the preceding embodiments, wherein a receiving surface of each bandpass filter defines a normal orientation, wherein at least one or each bandpass filter is arranged in a manner having a respective chief ray of a field of view impinging on the receiving surface of the respective bandpass filter being parallel to the normal orientation.

Embodiment 23: The spectrometer device according to anyone of the preceding embodiments, wherein the optical filter comprises a curved filter surface, particularly wherein the at least two bandpass filters are arranged on the curved filter surface.

Embodiment 24: The spectrometer device according to anyone of the preceding embodiments, wherein the at least one optical element comprises at least one mirror, particularly a flat mirror or an imaging mirror.

Embodiment 25: The spectrometer device according to the preceding embodiment, wherein the imaging mirror is selected from at least one of:
a curved mirror;
a free form mirror.

Embodiment 26: The spectrometer device according to anyone of the preceding embodiments, wherein the field of view of the at least one pixelated sensor is folded by increasing the optical path length between the detector array and the measurement window due to the modification of the field of view of the at least one pixelated sensor by the at least one optical element.

Embodiment 27: The spectrometer device according to the preceding embodiments, wherein the field of view of the at least one pixelated sensor is folded by modifying the direction of a chief ray of a respective field of view to have a directional component that is parallel to the detector array, particularly wherein an angle between the detector array and the direction of the chief ray is smaller than 0°, 20°, 40°, 60°or 80°, more particularly wherein the directional component accounts for at least 50%, 60%, 70%, 80%, 90% or 100% of the direction of the chief ray.

Embodiment 28: The spectrometer device according to anyone of the preceding embodiments, wherein the optical element comprises a mirror, particularly an imaging mirror.

Embodiment 29: The spectrometer device according to anyone of the preceding embodiments, wherein the field of view of the at least one pixelated sensor is focused due to the modification of the field of view of the at least one pixelated sensor by the at least one optical element, particularly on the measurement window, more particularly on the at least one overlap area.

Embodiment 30: The spectrometer device according to anyone of the preceding embodiments, wherein a chief ray of the field of view of the at least one pixelated sensor is redirected due to the modification of the field of view of the at least one pixelated sensor by the at least one optical element, particularly redirected towards a chief ray of a further field of view of a further at least one pixelated sensor of the at least two pixelated sensors, more particularly redirected towards a center of the at least one overlap area.

Embodiment 31: The spectrometer device according to anyone of the seven preceding embodiments, wherein the flat mirror has a flat reflecting surface.

Embodiment 32: The spectrometer device according to anyone of the eight preceding embodiments, wherein the imaging mirror has an at least partially curved reflecting surface, specifically an at least partially concave reflecting surface.

Embodiment 33: The spectrometer device according to anyone of the preceding embodiments, wherein the at least one optical element comprises a first mirror, particularly selected from at least one of:
a first flat mirror; or
a first imaging mirror,
   and wherein the at least one optical element comprises a second mirror, particularly selected from at least one of:
a second flat mirror; or
a second imaging mirror, and
   particularly wherein the at least one optical element comprises a further mirror, particularly selected from at least one of:
a further flat mirror; or
a further imaging mirror.

Embodiment 34: The spectrometer device according to anyone of the preceding embodiments, wherein the at least one optical element comprises a first flat mirror and a second flat mirror, wherein the first flat mirror is arranged in a direction of incidence of the incident radiation in front of the second flat mirror.

Embodiment 35: The spectrometer device according to the preceding embodiment, wherein the arrangement of the first flat mirror and the second flat mirror increases the at least one overlap area comprising the measurement spots of each field of view of the at least two pixelated sensors on the measurement window.

Embodiment 36: The spectrometer device according to anyone of the two preceding embodiments, wherein the arrangement of the first flat mirror and the second flat mirror is folding at least one or each field of view by increasing the optical path length between the detector array and the measurement window.

Embodiment 37: The spectrometer device according to anyone of the three preceding embodiments, wherein the first flat mirror reflects the incident radiation towards or onto the second flat mirror, wherein the second flat mirror reflects the incident radiation towards or onto the optical filter.

Embodiment 38: The spectrometer device according to anyone of the four preceding embodiments, wherein the reflecting surface of the first flat mirror and the reflecting surface of the second flat mirror are parallel.

Embodiment 39: The spectrometer device according to anyone of the preceding embodiments, wherein the at least one optical element comprises a first flat mirror and a second imaging mirror, wherein the first flat mirror is arranged in a direction of incidence of the incident radiation in front of the second imaging mirror.

Embodiment 40: The spectrometer device according to the preceding embodiment, wherein the arrangement of the first flat mirror and the second imaging mirror increases the at least one overlap area comprising the measurement spots of each field of view of the at least two pixelated sensors on the measurement window.

Embodiment 41: The spectrometer device according to anyone of the two preceding embodiments, wherein the arrangement of the first flat mirror and the second imaging mirror is folding at least one or each field of view by increasing the optical path length between the detector array and the measurement window.

Embodiment 42: The spectrometer device according to anyone of the three preceding embodiments, wherein the first flat mirror reflects the incident radiation towards or onto the second imaging mirror, wherein the second imaging mirror reflects the incident radiation towards or onto the optical filter.

Embodiment 43: The spectrometer device according to anyone of the four preceding embodiments, wherein second imaging mirror is focusing the field of views of the at least two pixelated sensors at the measurement window.

Embodiment 44: The spectrometer device according to the preceding embodiment, wherein the at least one optical element comprises a first imaging mirror and a second flat mirror, wherein the first imaging mirror is arranged in a direction of incidence of the incident radiation in front of the second flat mirror.

Embodiment 45: The spectrometer device according to the preceding embodiment, wherein the arrangement of the first imaging mirror and the second flat mirror increases the at least one overlap area comprising the measurement spots of each field of view of the at least two pixelated sensors on the measurement window.

Embodiment 46: The spectrometer device according to anyone of the two preceding embodiments, wherein the arrangement of the first imaging mirror and the second flat mirror is folding at least one or each field of view by increasing the optical path length between the detector array and the measurement window.

Embodiment 47: The spectrometer device according to anyone the three preceding embodiments, wherein the first imaging mirror reflects the incident radiation towards or onto the second flat mirror, wherein the second flat mirror reflects the incident radiation towards or onto the optical filter.

Embodiment 48: The spectrometer device according to anyone of the four preceding embodiments, wherein the first imaging mirror is focusing the field of views of the at least two pixelated sensors at the measurement window.

Embodiment 49: The spectrometer device according to anyone of the preceding embodiments, wherein the at least one optical element comprises a first imaging mirror and a second imaging mirror, wherein the first imaging mirror is arranged in a direction of incidence of the incident radiation in front of the second imaging mirror.

Embodiment 50: The spectrometer device according to the preceding embodiment, wherein the arrangement of the first imaging mirror and the second imaging mirror increases the at least one overlap area comprising the measurement spots of each field of view of the at least two pixelated sensors on the measurement window.

Embodiment 51: The spectrometer device according to anyone of the two preceding embodiments, wherein the arrangement of the first imaging mirror and the second imaging mirror is folding at least one or each field of view by increasing the optical path length between the detector array and the measurement window.

Embodiment 52: The spectrometer device according to anyone of the three preceding embodiments, wherein the first imaging mirror reflects the incident radiation towards or onto the second imaging mirror, wherein the second imaging mirror reflects the incident radiation towards or onto the optical filter.

Embodiment 53: The spectrometer device according to anyone of the four preceding embodiments, wherein the first imaging mirror and the second focusing are focusing the field of views of the at least two pixelated sensors at the measurement window.

Embodiment 55: The spectrometer device according to anyone of the five preceding embodiments, wherein the at least one optical element comprises a further imaging mirror.

Embodiment 56: The spectrometer device according to the preceding embodiment, wherein the further imaging mirror reflects the incident radiation from the second flat mirror towards or onto the optical filter.

Embodiment 57: The spectrometer device according to anyone of the two preceding embodiments, wherein the first imaging mirror reflects the incident radiation towards or onto the second imaging mirror, wherein the second imaging mirror reflects the incident radiation towards or onto the further imaging mirror, wherein the further imaging mirror reflects the incident radiation towards or onto the optical filter.

Embodiment 58: The spectrometer device according to anyone of the three preceding embodiments, wherein further imaging mirror is further focusing the field of views of the at least two pixelated sensors at the measurement window.

Embodiment 59: The spectrometer device according to the anyone of the preceding embodiments, wherein the at least one optical element increases the optical path length of the incident radiation from the measurement window to the detector array by at least 50 μm to 30 cm, 100 μm to 50 mm or 500 μm to 15 mm.

Embodiment 60: The spectrometer device according to the anyone of the twenty-seven preceding embodiments, wherein the optical path length between the first mirror and the second mirror is at least 50 μm to 30 cm, 100 μm to 50 mm or 500 μm to 15 mm.

Embodiment 61: The spectrometer device according to the anyone of the twenty-eight preceding embodiments, wherein the optical path length between the second mirror and the further mirror is at least 50 μm to 30 cm, 100 μm to 50 mm or 500 μm to 15 mm.

Embodiment 62: The spectrometer device according to the preceding embodiment, wherein the detector array comprises at least two further pixelated sensors, wherein the at least one optical element is configured for generating at least one further overlap between the field of views of the at least two further pixelated sensors at the measurement window, particularly at least one further overlap area comprising further measurement spots of each further field of view of the at least two further pixelated sensors.

Embodiment 63: The spectrometer device according to anyone of the preceding embodiments, wherein the spectrometer device comprises at least one radiation emitting element, wherein the at least one radiation emitting element is configured for emitting optical radiation.

Embodiment 64: The spectrometer device according to the preceding embodiment, wherein the at least one radiation emitting element is comprised by at least one of a thermal radiator or a semiconductor-based radiation source.

Embodiment 65: The spectrometer device according to the preceding embodiment, wherein the thermal radiator is selected from an incandescent lamp or a thermal infrared emitter.

Embodiment 66: A spectrometer system, comprising
a spectrometer device for detecting incident radiation generated by an object according to any one of the preceding embodiments; and
an evaluation device configured for determining information related to a spectrum of the object by evaluating at least one detector signal provided by the spectrometer device.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the figures:

FIG. 1 shows exemplarily a first spectrometer device without an optical element; and

FIG. 2 shows exemplarily a second spectrometer device having an optical element, particularly two apertures; and

FIG. 3 shows exemplarily a third spectrometer device having an optical element, particularly a flat mirror; and

FIG. 4 shows exemplarily a fourth spectrometer device having an optical element, particularly two flat mirrors; and

FIG. 5 shows exemplarily a fifth spectrometer device having an optical element, particularly a flat mirror and an imaging mirror; and

FIG. 6 shows exemplarily a sixth spectrometer device having an optical element, particularly a flat mirror and an imaging mirror in a further arrangement; and

FIG. 7 shows exemplarily a seventh spectrometer device having an optical element, particularly three imaging mirrors.

### DETAILED DESCRIPTION OF THE EMBODIMENTS

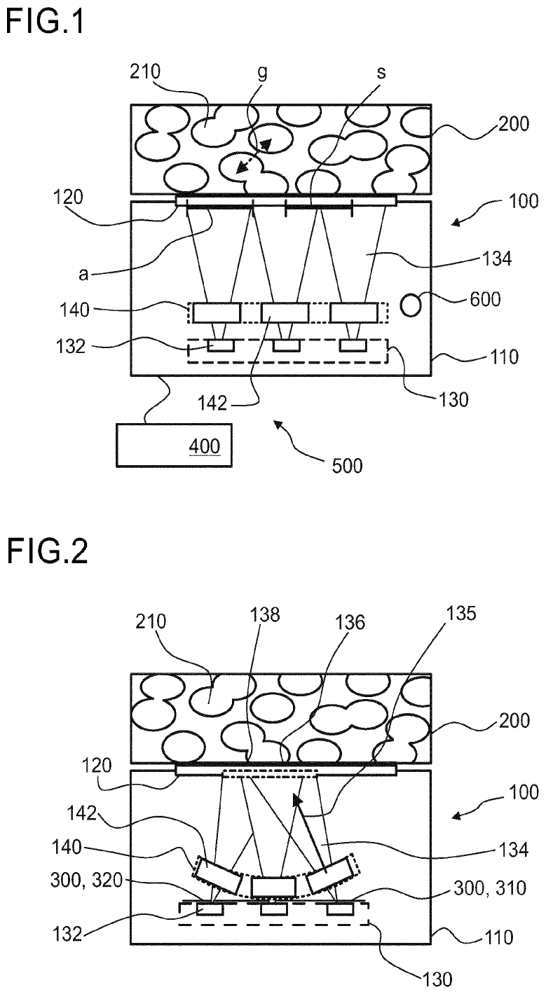

According to FIG. 1 a spectrometer device 100 for detecting incident radiation generated by an object 200 is comprising a measurement window 120 configured for accepting incident radiation generated by the object 200 to enter a housing 110 of the spectrometer device 100.

A detectable wavelength range of the incident radiation may be ranging from 400 nm to 10 μm, specifically from 400 nm to 1 μm, and/or from 900 nm to 3 μm, specifically wherein the at least two pixelated sensors 132 may be PbS sensors, and/or from 600 nm to 5 μm, specifically wherein the at least two pixelated sensors 132 may be PbSe sensors.

The spectrometer device 100 is further comprising a detector array 130 comprising at least two pixelated sensors 132 each having a field of view 134 designed for accepting at least a portion of the incident radiation, wherein each pixelated sensor 132 is configured for generating at least one detector signal related to the accepted incident radiation.

Typically, each field of view 134 may be conical, particularly wherein each field of view 134 may have an Full Width Half Maximum, FWHM, opening angle y of less than 60°, 40°or 20°. The at least one optical element 300 may be configured for modifying the field of view 134 of each pixelated sensor 132 for increasing the at least one overlap between the field of views 134, as exemplarily shown in FIGS. 2 to 7.

The spectrometer device 100 is further comprising an optical filter 140, wherein the optical filter is arranged within the field of views 134 of the at least two pixelated sensors 132, wherein the optical filter 140 is configured for generating a spectrum of at least two separated wavelength signals from the incident radiation and transmitting the at least two separated wavelength signals onto the respective at least one pixelated sensors 132. The measurement window 120 may be parallel to a filter surface comprising the at least two pixelated sensors 132.

Each field of view 134 may be sensitive to a granularity of the object 200 that may be generated by constituents 210 of the object 200, as a width a of the field of views 134 and a distance s between two adjacent fields of views 134 is within the order of magnitude of a typical structure size g of the constituents 210 of the object 200. Particularly in case the field of views 134 are directed at different portions of the object 200, the sensor signals generated by the pixilated sensors 132 may be influenced by the granularity of the object 200.

Typically, the spectrometer device 100 may comprises at least one radiation emitting element 600. The at least one radiation emitting element 600 may be configured for emitting optical radiation. The at least one radiation emitting element 600 may be comprised by a thermal radiator and/or a semiconductor-based radiation source. The thermal radiator may be an incandescent lamp and/or a thermal infrared emitter.

Further typically, an evaluation device 400 may be configured for determining information related to a spectrum of the object 200 by evaluating at least one detector signal provided by the spectrometer device 100. The evaluation device 400 and the spectrometer device 100 may be comprised by a spectrometer system 500.

According to FIG. 2 a spectrometer device 100 for detecting incident radiation generated by the object 200 is further comprising at least one optical element 300 configured for modifying the field of view 134 of at least one pixelated sensor 132 by increasing at least one overlap between the field of views 134 of the at least two pixelated sensors 132. Thereby, at least one overlap between the field of views 134 of the at least two pixelated sensors 132 may result in an increased at least one overlap area 136 comprising measurement spots of each field of view 134 of the at least two pixelated sensors 132 on the measurement window 120.

Further, a ratio between the at least one overlap area 136 generated by the measurement spots of each field of view 134 of the at least two pixelated sensors 132 and a combined area 138 generated by the measurement spots of each field of view 134 of the at least two pixelated sensors 132 on the measurement window 120 may be at least 60 %, 70 %, 80 % or 90 %. A further ratio between a distance between two chief rays 135 of the field of views 134 of at least two adjacent pixelated sensors 132 of the at least two pixelated sensors 132 on the measurement window 120 and the width a of the measurement spots of each field of view 134 of at least two adjacent pixelated sensors 132 may be below 35%, 25 %, 15 %, 10 %, 8% or 5%.

The at least one optical element 300 may be or may comprise at least one aperture 310 for trimming the field of view 134 of at least one pixelated sensor 132, as exemplarily depicted in FIG. 2. Thereby a chief ray 135 of the field of view 134 of at least one pixelated sensor 132 may be aligned, particularly towards a center of the overlap area 136. The at least one optical element 300 may comprises at least one further aperture 320 for trimming the field of view 134 of at least one further pixelated sensor 132, particularly and thereby aligning a further chief ray 135 of the field of view 134 of the at least one further pixelated sensor 132, particularly towards the center of the overlap area 136, as depicted exemplarily in FIG. 2. An angle a between the chief ray and the further chief ray 135 at the measurement window 120 may be above 0°, 5°, 10°, 20°, 40°or 60°.

The optical filter 140 may be selected from or may comprise a length variable filter and/or a static filter and/or a tunable filter, specifically a MEMS Fabry-Perot cavity, and/or an optical lens and/or a diffractive element. The length variable filter may comprise at least two bandpass filters 142, wherein each bandpass filter 142 may be assigned to a respective pixelated sensor 132 by being arranged within the field of view 134 of the respective pixelated sensor 132. Each bandpass filter 142 may be configured for selecting at least one wavelength or a range of wavelengths of the accepted incident radiation.

The at least two pixelated sensors 132 may be arranged on a detector plane next to each other, particularly wherein the detector plane may be a flat plane. The at least two pixelated sensors 132 may be arranged in a line. The at least two bandpass filters 142 may be arranged on the filter surface, particularly wherein the filter surface is curved. The at least two bandpass filters 142 may be arranged in a line. Each bandpass filter 142 may be aligned to a respective pixelated sensor 132 with regard to a respective field of view 134 of the respective pixelated sensor 132, particularly to a chief ray 135 of the field of view 134 of the respective pixelated sensor 132.

Each bandpass filter 142 may have an acceptance angle, wherein at least one or each bandpass filter 142 may be arranged in a manner having a respective chief ray 135 of a field of view 134 impinging on the respective bandpass filter 142 within the acceptance angle. A receiving surface of each bandpass filter 142 may define a normal orientation, wherein at least one or each bandpass filter 142 may be arranged in a manner having a respective chief ray 135 of a field of view 134 impinging on the receiving surface of the respective bandpass filter 142 being parallel to the normal orientation. The optical filter 140 may comprise a curved filter surface, particularly wherein the at least two bandpass filters 142 may be arranged on the curved filter surface.

The measurement window 120 may be parallel to the detector plane. An optical path length between the measurement window 120 and the detector plane may be between 50 μm to 30 cm or between 100 μm to 50 mm or between 500 μm to 15 mm.

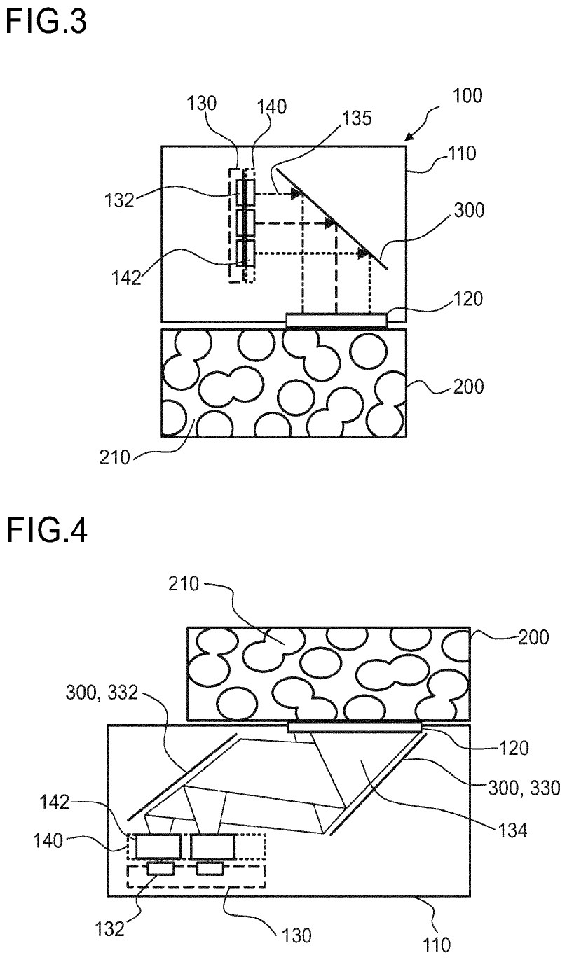

Alternatively or in addition, the at least one optical element 300 may comprise a flat mirror. The flat mirror may have a flat reflecting surface. A spectrometer device 100 comprising a flat mirror exclusively is depicted in FIG. 3. Alternatively or in addition, the at least one optical element 300 may comprise an imaging mirror, particularly exclusively. The imaging mirror may be a curved mirror and/or a free form mirror. The imaging mirror may have an at least partially curved reflecting surface, specifically an at least partially concave reflecting surface. The imaging mirror may focus the field of view 134 of the at least two pixelated sensors 132 at the measurement window 120. Particularly by using a flat and/or a curved mirror the at least one optical element 300 may be folding the at least one field of view 134 or each field of view 134 by increasing the respective optical path length between the detector array 130 and the measurement window 120.

The at least one field of view 134 or each field of view 134 may be folded by modifying the direction of a chief ray 135 of a respective field of view 134 to have a directional component that is parallel to the detector array 130, particularly wherein an angle between the detector array and the direction of the chief ray is smaller than 0°, 20°, 40°, 60°or 80°, more particularly wherein the directional component accounts for at least 50%, 60%, 70%, 80%, 90% or 100% of the direction of the chief ray 135.

Typically, the at least one optical element 300 may comprise a first mirror, particularly a first flat mirror 330 or a first imaging mirror 336, and the at least one optical element 300 may comprise a second mirror, particularly a second flat mirror 332 or a second imaging mirror 334. In addition, the at least one optical element 300 may comprise a further mirror, particularly a further flat mirror or a further imaging mirror 338.

Alternatively or in addition, as exemplarily shown in FIG. 4, the at least one optical element 300 may comprise a first flat mirror 330 and a second flat mirror 332, wherein the first flat mirror 330 may be arranged in a direction of incidence of the incident radiation in front of the second flat mirror 332. The arrangement of the first flat mirror 330 and the second flat mirror 332 may increase the at least one overlap area 136 comprising the measurement spots of each field of view 134 of the at least two pixelated sensors 132 on the measurement window 120. The arrangement of the first flat mirror 330 and the second flat mirror 332 may be folding at least one or each field of view 134 by increasing the respective optical path length between the detector array 130 and the measurement window 120.

The first flat mirror 330 may reflect the incident radiation towards or onto the second flat mirror 332, wherein the second flat mirror 332 may reflect the incident radiation towards or onto the optical filter 140. The reflecting surface of the first flat mirror 330 and the reflecting surface of the second flat mirror 332 may be parallel.

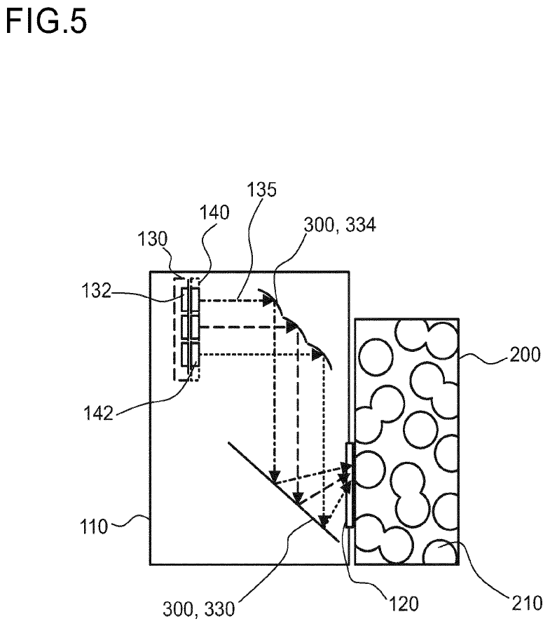

Alternatively or in addition, as exemplarily shown in FIG. 5, the at least one optical element 300 may comprise a first flat mirror 330 and a second imaging mirror 334 wherein the first flat mirror 330 may be arranged in a direction of incidence of the incident radiation in front of the second imaging mirror 334. The arrangement of the first flat mirror 330 and the second imaging mirror 334 may increase the at least one overlap area 136 comprising the measurement spots of each field of view 134 of the at least two pixelated sensors 132 on the measurement window 120.

The arrangement of the first flat mirror 330 and the second imaging mirror 334 may be folding at least one or each field of view 134 by increasing the respective optical path length between the detector array 130 and the measurement window 120. The first flat mirror 330 may reflect the incident radiation towards or onto the second imaging mirror 334, wherein the second imaging mirror 334 may reflect the incident radiation towards or onto the optical filter 140. The second focusing 334 mirror may be focusing the field of view 134 of the at least one pixelated sensors 132 at the measurement window 120. Alternatively or in addition, the chief rays 135 of the field of views 134 of the at least two pixelated sensors 132 may be directed towards a center of the at least one overlap area 136 at the measurement window 120 by the second imaging mirror 334.

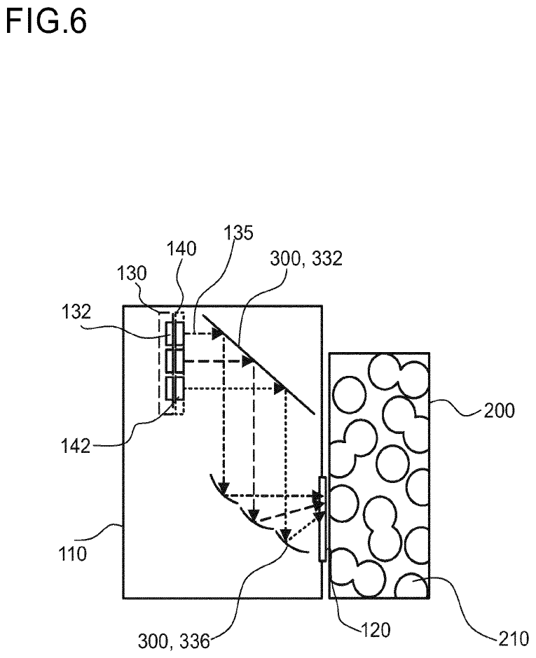

Alternatively or in addition, as exemplarily shown in FIG. 6, the at least one optical element 300 may comprise a first imaging mirror 336 and a second flat mirror 332, wherein the first imaging mirror 336 may be arranged in a direction of incidence of the incident radiation in front of the second flat mirror 332. The arrangement of the first imaging mirror 336 and the second flat mirror 332 may increase the at least one overlap area 136 comprising the measurement spots of each field of view 134 of the at least two pixelated sensors 132 on the measurement window 120.

The arrangement of the first imaging mirror 336 and the second flat mirror 332 may be folding at least one or each field of view 134 by increasing the respective optical path length between the detector array 130 and the measurement window 120. The first imaging mirror 336 may reflect the incident radiation towards or onto the second flat mirror 332, wherein the second flat mirror 332 may reflect the incident radiation towards or onto the optical filter 140. The first imaging mirror 336 may focus the field of view 134 of the at least one pixelated sensors 132 at the measurement window 120. Alternatively or in addition, the chief rays 135 of the field of views 134 of the at least two pixelated sensors 132 may be directed towards a center of the at least one overlap area 136 at the measurement window 120 by the first imaging mirror 336.

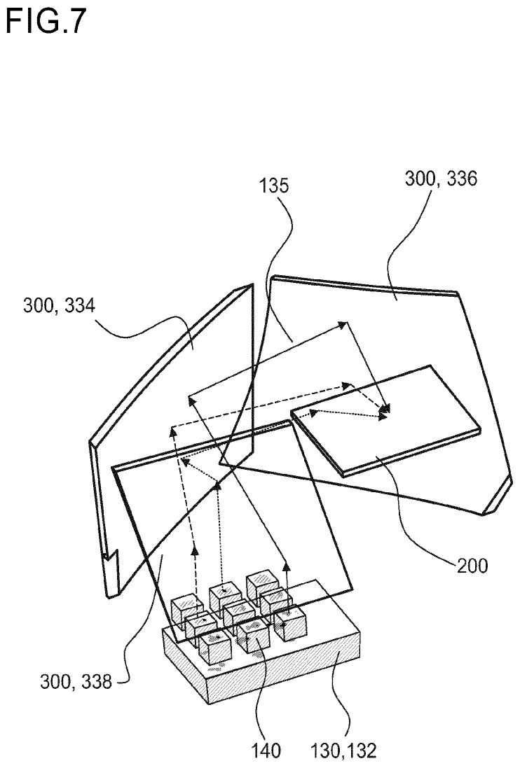

Alternatively or in addition, as exemplarily shown in FIG. 7, the at least one optical element 300 may comprise a first imaging mirror 336 and a second imaging mirror 334, wherein the first imaging mirror 336 may be arranged in a direction of incidence of the incident radiation in front of the second imaging mirror 334. The arrangement of the first imaging mirror 336 and the second imaging mirror 334 may increase the at least one overlap area 136 comprising the measurement spots of each field of view 134 of the at least two pixelated sensors 132 on the measurement window 120.

The arrangement of the first imaging mirror 336 and the second imaging mirror 334 may be folding at least one or each field of view 134 by increasing the respective optical path length between the detector array 130 and the measurement window 120. The first imaging mirror 336 may reflect the incident radiation towards or onto the second imaging mirror 334, wherein the second imaging mirror 334 may reflect the incident radiation towards or onto the optical filter 140. The first imaging mirror 336 and the second imaging mirror 334 may focus the field of views 134 of the at least two pixelated sensors 132 at the measurement window 120. Alternatively or in addition, the chief rays 135 of the field of views 134 of the at least two pixelated sensors 132 may be directed towards each other at the measurement window 120 by the first imaging mirror 336 and the second imaging mirror 334.

Optionally, as depicted in Fig, 7, the at least one optical element 300 may comprise a further imaging mirror 338. The further imaging mirror 338 may reflect the incident radiation from the second imaging mirror 334 towards or onto the optical filter 140. The first imaging mirror 336 may reflect the incident radiation towards or onto the second imaging mirror 334, wherein the second imaging mirror 334 may reflect the incident radiation towards or onto the further imaging mirror 338, wherein the further imaging mirror 338 may reflect the incident radiation towards or onto the optical filter 140. The further imaging mirror 338 may further focus the field of view 134 of the at least one pixelated sensors 132 at the measurement window 120. Alternatively or in addition, the chief rays 135 of the field of views 134 of the at least two pixelated sensors 132 may be further directed towards each other at the measurement window 120 by the further imaging mirror 338. Alternatively the further mirror may be a further flat mirror.

Typically, the at least one optical element 300 may increase the optical path length of the incident radiation from the measurement window 120 to the detector array 130 by at least 50 μm to 30 cm, 100 μm to 50 mm or 500 μm to 15 mm. The optical path length between the first mirror and the second mirror may be at least 50 μm to 30 cm, 100 μm to 50 mm or 500 μm to 15 mm. The optical path length between the second mirror and the further mirror may be at least 50 μm to 30 cm, 100 μm to 50 mm or 500 μm to 15 mm.

Typically, the detector array 130 may comprise at least two further pixelated sensors 132, wherein the at least one optical element 300 may be configured for generating at least one further overlap between the field of views 134 of the at least two further pixelated sensors 132 at the measurement window 120, particularly at least one further overlap area 136 may comprise further measurement spots of each further field of view 134 of the at least two further pixelated sensors 132.

### LIST OF REFERENCE NUMBERS

100 spectrometer device
110 housing
120 measurement window
130 detector array
132 pixelated sensor
134 field of view
135 chief ray
136 overlap area
138 combined area
140 optical filter
142 bandpass filter
200 object
210 constituents
300 optical element
310 aperture
320 further aperture
330 first flat mirror
332 second flat mirror
334 second imaging mirror
336 first imaging mirror
338 further imaging mirror
400 evaluation device
500 spectrometer system
600 radiation emitting element
a width
g structure size
S distance

1. A spectrometer device for detecting incident radiation generated by an object comprising:
a measurement window configured for accepting incident radiation generated by an object to enter the spectrometer device wherein the measurement window is at least one of: a contact surface, or a lay-on-surface for the object to be investigated;
a detector array comprising at least two pixelated sensors each having a field of view designed for accepting at least a portion of the incident radiation, wherein each pixelated sensor is configured for generating at least one detector signal related to the accepted incident radiation;
an optical filter wherein the optical filter is arranged within the field of views of the at least two pixelated sensors wherein the optical filter is configured for generating a spectrum of at least two separated wavelength signals from the incident radiation and transmitting the at least two separated wavelength signals onto the respective at least one pixelated sensor;
at least one optical element configured for modifying the field of view of at least one pixelated sensor by increasing at least one overlap between the field of views of the at least two pixelated sensors wherein the at least one optical element comprises a first mirror selected from at least one of:
a first flat mirror; or
a first imaging mirror,
and wherein the at least one optical element comprises a second mirror selected from at least one of:
a second flat mirror; or
a second imaging mirror.

2. The spectrometer device according to claim 1, wherein increasing the at least one overlap between the field of views of the at least two pixelated sensors results in an increased at least one overlap area comprising measurement spots of each field of view of the at least two pixelated sensors on the measurement window.

3. The spectrometer device according to claim 1, wherein the optical filter is a length variable filter, wherein the length variable filter comprises at least two bandpass filters wherein each bandpass filter is assigned to a respective pixelated sensor by being arranged within the field of view of the respective pixelated sensor wherein each bandpass filter is configured for selecting at least one wavelength of the accepted incident radiation.

4. The spectrometer device according to claim 2, wherein a ratio between the at least one overlap area generated by the measurement spots of each field of view of the at least two pixelated sensors and a combined area generated by the measurement spots of each field of view of the at least two pixelated sensors on the measurement window is at least 60 %, 70 %, 80 % or 90 %.

5. The spectrometer device according to claim 1, wherein a field of view of a first pixelated sensor of the at least two pixelated sensors is tilted in respect to a field of view of a second pixelated sensor of the at least two pixelated sensors due to the modification of the field of view of the at least one pixelated sensor by the at least one optical element.

6. The spectrometer device according to claim 1, wherein the at least one optical element comprises at least one aperture for trimming the field of view of at least one pixelated sensor.

7. The spectrometer device according to claim 1, wherein the at least one optical element comprises at least one mirror, mirror.

8. The spectrometer device according to claim 1, wherein the field of view of the at least one pixelated sensor is folded by increasing the optical path length between the detector array and the measurement window due to the modification of the field of view of the at least one pixelated sensor by the at least one optical element.

9. The spectrometer device according to claim 8, wherein the field of view of the at least one pixelated sensor is folded by modifying the direction of a chief ray of the field of view to have a directional component that is parallel to the detector array wherein an angle between the detector array and the direction of the chief ray is smaller than 0°, 20°, 40°, 60°or 80°.

10. The spectrometer device according to claim 1, wherein the field of view of the at least one pixelated sensor is focused due to the modification of the field of view of the at least one pixelated sensor by the at least one optical element.

11. The spectrometer device according to claim 1, wherein a chief ray of the field of view of the at least one pixelated sensor is redirected due to the modification of the field of view of the at least one pixelated sensor by the at least one optical element.

12. The spectrometer device according to claim 1, wherein the at least one optical element comprises a further mirror selected from at least one of:
a further flat mirror; or
a further imaging mirror.

13. The spectrometer device according to claim 1, wherein the spectrometer device comprises at least one radiation emitting element wherein the at least one radiation emitting element is configured for emitting optical radiation.

14. A spectrometer system comprising
a spectrometer device for detecting incident radiation generated by an object according to claim 1; and
an evaluation device configured for determining information related to a spectrum of the object by evaluating at least one detector signal provided by the spectrometer device.

15. The spectrometer device according to claim 1, wherein the at least one optical element comprises a flat mirror or an imaging mirror.
